(19) United States
(12) Patent Application Publication
(10) Pub. No.: US 2011/0040871 A1
(43) Pub. Date: Feb. 17, 2011

(54) MONITORING WEBSITE VISITS FROM ON-LINE ENQUIRY AND VIEWS OF ELECTRONIC DOCUMENTS TO OFF-LINE (DELAYED) PURCHASE

(76) Inventor: Mark Neal, Birmingham (GB)

Correspondence Address: NOTARO, MICHALOS & ZACCARIA P.C., 100 DUTCH HILL ROAD, ORANGEBURG, NY, 10962, US

(21) Appl. No.: 12/856,189

(22) Filed: Aug. 13, 2010

(30) Foreign Application Priority Data
Aug. 13, 2009 (GB) 0914183.9

(51) Int. Cl. G06F 15/173

(52) U.S. Cl. 709/224

(57) ABSTRACT

A system for monitoring website visits is implemented by an implementing server (110) in communication with a host server (101) hosting a website owned by a website operator (104). The implementing server comprises an identification module (111), a communication module (112), a database module (113), and an association module (114). The identification module identifies a user (102) as a new visitor or as a return visitor and assigns a unique user code to the user or retrieves a previously assigned unique user code associated with the user. The communication module (112) provides the user with the unique user code and receives user information provided by the user. On entry to the website, the user receives a cookie which comprises the unique user code as well as other user related information. The user may be prompted to enter their unique user code into communications with the website, or the unique user code may be automatically attached to communications.

### FIELD AND BACKGROUND OF THE INVENTION

The present invention relates to the monitoring of website visits, interaction and views of electronic documents and in particular to a system and method for achieving such monitoring. In particular, the system and method are operable to enable data relating to offline enquires, orders or sales to be associated with data relating to website visits.

In many instances companies take care to monitor visitors to their website. This can be achieved by use of a simple download counter logging the number of page impressions. More sophisticated systems may identify the visitor by means of their IP address and keep a track of the number of unique visitors (as defined by unique IP addresses) and/or the number of repeat visits. A further track can be kept of the number of visits per visitor or per page impression that lead to sales. If however a visitor chooses to obtain information from a website but complete a sale via offline means (e.g. telephone, in person, by post etc.) it is not possible to associate this sale with their previous visits to the website. This can distort the sales effectiveness data obtained from monitoring of a website.

### SUMMARY OF THE INVENTION

It is an object of the present invention to provide an improved system and method of monitoring website visits that overcomes or alleviates the above problems.

According to a first aspect of the present invention there is provided a system for monitoring website visits, the system comprising: an identification module operable to identify a user as a new visitor or as a returning visitor and thereby assign a new unique user code or retrieve a previously assigned unique user code associated with the user; a communication module operable to provide the user with the unique user identification code and to receive user information data provided by the user; a database module operable to store visit information data related to the or each visit to the webpage by a user associated with a particular unique user code; and an association module operable to associate user information data incorporating the unique user code with prior visit information data.

According to a second aspect of the present invention there is provided a method for monitoring website visits, the method comprising: identifying a user of a website as a new visitor or a as returning visitor and if the user is a new visitor assigning the user a new unique user code, and if the user is a returning visitor retrieving a previously assigned user code associated with the user; providing the unique user code to the user; storing in a database visit information data related to the or each visit to the webpage by a user associated with a particular unique user code; receiving user information data incorporating the unique user code; and thereby associating received user information data with prior visit information data.

The unique user code provides a means by which a user can be identified and thus prior website visits can be associated with later provided user information data, whether this data is provided online or offline.

The unique user code may be provided to the user by display of the code on one or more pages of the website. The user may then provide the code by including it in a communication with the website operator. Additionally or alternatively, the unique user code may be provided by automatically attaching it to communications sent by the user to the website operator, for example added to the contact form data.

The user may be identified by their IP address, caller ID from mobile device or VOIP identifier. Additionally or alternatively, the user may be identified by a cookie. Such a cookie may be provided on the first visit to the website. In the event that a user deletes this cookie, a replacement cookie may be provided on a subsequent visit.

The unique user code may be provided to the user within a cookie. The cookie may be operable to display the unique user code to the user directly and/or to attach the unique user code to user communications with the website operator.

A cookie may be provided which is operable to record visit information data and communicate this data to the association module. Alternatively, the website host may be operable to directly record requests for pages from a user.

Visit information data may comprise any one or all of the following for the or each visit: time of visit, duration of visit, time elapsed since last visit, number of visits, identity of pages viewed within the site, duration of view of identified pages within the site, identity of documents or applications downloaded from the site, viewing device properties, browser properties, IP address, user host, method of reaching website, site linked from, search engine used, search term used, page ranking on search engine, pay per click provider or similar.

The user may communicate with the system by filling a web form provided on the site. The web form may comprise an order for sales, a request for information, a request for after sales service or similar. Where the user communicates by way of a web form, the unique user code may be attached to the web form. Alternatively, the user may be provided with a field for entering their unique user code.

Additionally or alternatively, the user may communicate by way of email. In such cases, the unique user code may be automatically attached to the email or inserted into the text, or subject line, of the email. Alternatively, a user may be prompted to provide their unique user code within the email.

Additionally or alternatively, the user may communicate by way of a conversation with a representative in person, online or via a telephone network. In such cases, the user may be asked to provide their unique user code. The code may be provided by the user entering the code using a keypad, keyboard or the like, perhaps using a touchtone telephone handset. Alternatively, the code may be provided by speaking the code to voice recognition software or a human representative.

Additionally or alternatively, the user may communicate by way of post, fax or other paper based communications. In such cases, the user may be asked to provide their unique user code within the paper based communication. The code may be extracted by means of optical character recognition.

The communication module may be operable to automatically extract the unique user code when it is attached to communications or when it is input by a user or when it is contained within a user communication. Additionally or alternatively, the communication module may be provided with or connected to a local or remote data input interface operable to enable an operator to input a unique user code.

The identification module, communication module, database module and association module may be implemented on a server or other suitable device in communication with the server hosting the website. The system may be operable to identify users viewing the website using any suitable viewing device. Suitable viewing devices may include but are not limited to: personal computers (whether desktop, laptop, note book or otherwise), telephones (whether fixed line, cellular, or otherwise), personal digital assistants, personal media viewers/players or similar.

### BRIEF DESCRIPTION OF THE DRAWING

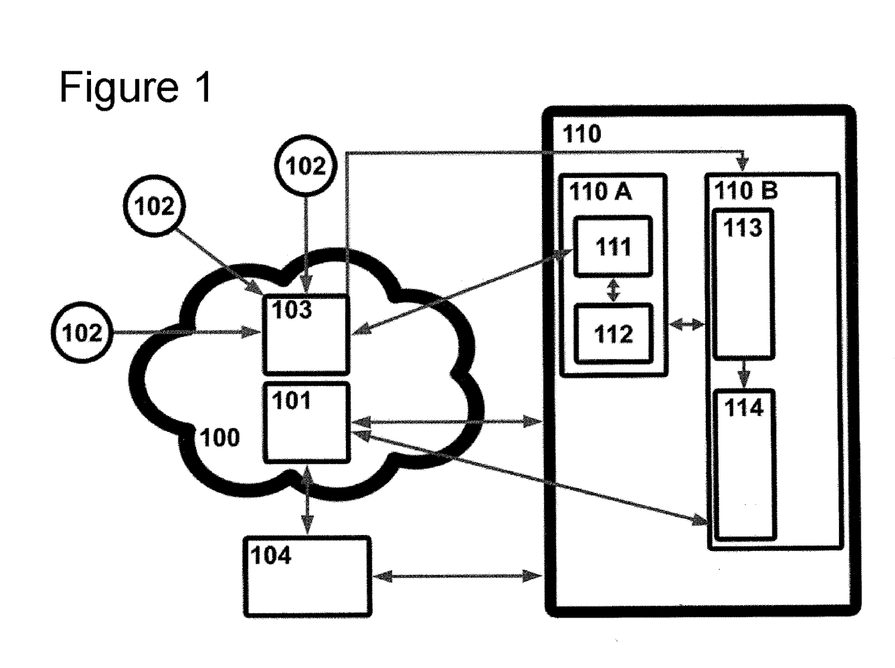

In order that the invention is more clearly understood, one embodiment will be described further herein, by way of example only, and with reference to the following drawings, the single FIGURE of which, FIG. 1, is a schematic block diagram of a system according to the present invention.

### DESCRIPTION OF THE PREFERRED EMBODIMENTS

Referring now to FIG. 1, a system for monitoring website visits is implemented by an implementing server 110. The server 110 is in communication with a host server 101 hosting the website via a suitable link. The host server 101 publishes the website to the internet 100. Pages from the website can thus be downloaded by one or more user devices and viewed thereon by the users 102.

A website operator 104 registers to use the system of the present invention with the host server 101. A connection is then provided between the host server and the implementing server 110.

The implementing server 110 of the present example has two modules, 110A and 110B. The first module 110A is concerned with identifying the website users and with communications to/from the website users and comprises an identification module 111 and a communication module 112. The second module 110B is concerned with storing information on website users 102 and associating the stored information with identified website users 102 and comprises a database module 113 and an association module 114. The skilled man will of course appreciate that a single module server may alternatively be employed to implement the invention.

On registration, the website operator 104 receives a unique operator ID and is allocated as an operator in the database 113 of module 110B. The operator 104 registers the particular website(s) to be tracked 103 and each website is given its own unique ID and table in the operator's database 113. The operator 104 then receives the necessary tracking code to implement the system (including a contact form if necessary) on their website(s).

The identification module 111 (A subsection of module 111 can be run on the same server as the website 103) is operable to identify a user 102 as a new visitor or as a returning visitor and thereby assign a new unique user code or retrieve a previously assigned unique user code associated with the user 102. The communication module 112 is operable to provide the user 102 with the unique user identification code and to receive user information data provided by the user 102. The database module 113 is operable to store visit information data related to the or each visit to the webpage by a user 102 associated with a particular unique user code. The association module 114 is operable to associate user information data incorporating the unique user code with prior visit information data, or to track the opening of an electronic sales brochure (PDF)

In use, the identification module 111 is activated on each occasion a request to view the website is received by the host server, or as a batch basis with server 101 allocating a unique ID based on an algorithm allocated by 111. Users 102 visiting a participating website 103 receive a cookie on entry. The cookie is served via the server module 110A which allocates them a unique visitor ID (related to the website ID and operator ID) according to the identification module 111 and the communication module 112. The server module 110A reports to the server module 110B which creates a visitor record in the appropriate table in the operator's database 113. The identification module identifies the user 102 by the IP address of their device, or if they have previously visited, from a cookie previously installed on the device. For requests from new IP addresses, a new unique user code is generated whilst for repeat visitors a previously generated unique user code is updated.

The above mentioned cookie may be automatically provided to new users. In the event that a returning user has deleted their cookie a replacement cookie can be provided, if desired.

The user's behaviour whilst visiting a website 103, is monitored via the tracking code running on the website 103. The monitored behaviour is reported to the server module 110B and the data is recorded by the database module 113. The database module 113 is operable to store information relating to viewing of the website by different users 102 as identified by their unique user codes. The data stored may relate to the viewing of the website e.g. duration of viewing, time elapsed between visits, pages viewed, documents or applications downloaded etc. Additionally, the database module may store data relating to the users's device and or the user's browser including the type of device, type of connection, IP address, display features, browser type etc. The database module may further be operable to store information relating to how the user arrived at the website. This may include the site linked from, search engine used, search terms used, and if a pay per click link has resulted in the viewing of the site, the identity of the pay per click provider. This can thus build up a record of the activity of different users of the website.

The unique user code is supplied to the user's device 102 by the communication module 112, alongside the supply of the website by host server. Typically, the code is contained in a cookie which is operable to attach the code to any communications between the user 102 and the website operator 104 that are initiated via the website. Additionally, the code is displayed on the website as viewed on the user's device. This display might be achieved by use of a cookie or by any other suitable method.

Accordingly, if the user 102 fills in a web form or requests to email, or Live Chat, or text chat to, the website operator 104 using a button provided on the web site, the unique user number is attached to the web form data, live chat data, text chat data, or the email. An information request or a sales order made via email or a web form can thus be identified as coming from a user with a particular IP address and or cookie and or caller ID. As such, previous visits to the website made by this user 102 can now be identified, if they are stored in the database module 113. The association module 114 can then associate this data relating to previous visits to the website with any further data provided in the email or web form. In this manner, website visits can be reliably associated with further sales activity or information requests. The website operator 104 may be able to access to their user visit information via a web interface. The web interface may allow the operator 104 to be presented with the appropriate statistics relating to the website(s) 103 registered with the service in a suitable numerical, textual or graphical form.

Since the unique user code is displayed on the website, the user 102 can quote this code in other communications with the website operator 104. This therefore allows other activities such as sales or information requests generated after views of the website to be associated with previous web activity. An example as to how this might work is that a user 102 may view the website and wish to discuss a product with a sales person before committing to a purchase. Accordingly, the user 102 may contact a sales representative via a telephone. When doing so, the user 102 may be prompted to provide the unique user code displayed when they visit the web site. In order to encourage users to do so either the website or the call may inform the users 102 of potential benefits to them in doing so, for instance, discounts, special offers or entries into prize draws.

The user 102 may provide the code by using their telephone keypad, by speaking to a voice recognition device or by speaking to the sales representative. In the first two instances, such data is automatically passed to the database module 113; in the latter case, a suitable interface is provided for the sales representative. In this manner, website activity that leads to offline sales can be identified and associated with said sales. The skilled man will of course appreciate that the system could equally be adapted to work with personal visits by the user to a shop or office or with paper based communications with a shop or office.

Further information can also be tracked if an electronic document is sent to the visitor (prospect) 102, the unique ID is embedded in the electronic document and each time the visitor (prospect) 102 opens the electronic document the database 110B is updated providing improved visibility of a prospects route to a final sale. Also at this stage it is possible to inform the sales operative that a visitor (prospect) has opened a document and shown additional interest in the product offered for sale to the visitor 102.

It is of course to be understood that the present invention is not to be limited to the details of the above embodiment which are described by way of example only.

1. A system for monitoring website visits, the system comprising:
An identification module operable to identify a user as a new visitor or as a returning visitor and thereby assign a new unique user code or retrieve a previously assigned unique user code associated with the user;
A communication module operable to provide the user with the unique user identification code and to receive user information data provided by the user;
A database module operable to store visit information data related to the or each visit to the webpage by a user associated with a particular unique user code;
And an association module operable to associate user information data incorporating the unique user code with prior visit information data.

2. A system according to claim 1, wherein the communication module is operable to provide the unique user code to the user by display of the code on one or more pages of a website.

3. A system according to claim 1, wherein the communication module is operable to automatically attach the unique user code to communications sent by the user to the website operator.

4. A system according to claim 1, wherein the communication module is operable to automatically extract the unique user code from a communication sent by the user to the website operator.

5. A system according to claim 1, wherein the identification module is operable to identify the user by means of any or all of an IP address, caller ID from a mobile device, VOIP identifier, or a cookie.

6. A system according to claim 1, wherein the communication module provides a cookie which is operable to display the unique user code to the user and/or to attach the unique user code to user communications with the website operator.

7. A system according to claim 1, wherein the communication module provides a cookie which is operable to record visit information data and communicate this data to the association module.

8. A system according to claim 1, wherein the communication module is operable to receive a communication from the user, wherein the communication is in the form of any or all of: a webform, an email, a conversation in person, online, or via a telephone network, post, or a fax.

9. A system according to claim 7, wherein the communication module comprises voice recognition software.

10. A system according to claim 7, wherein the communication module comprises optical character recognition means.

11. A system according to claim 1, where the communication module is provided with or connected to a local or remote data input interface to enable an operator to input a unique user code.

12. A system according to claim 1, wherein the identification module, communication module, database module, and association module are implemented on a server

13. A system according to claim 1, wherein the identification module, communication module, database module, and association module are implemented on a suitable device in communication with a server hosting the website.

14. A method for monitoring website visits, the method comprising:
Identifying a user of a website as a new visitor or as a returning visitor and if the user is a new visitor assigning the new user a unique user code, and if the user is a returning visitor retrieving a previously assigned user code associated with the user;
Providing the unique user code to the user;
Storing in a database visit information data related to the or each visit to the webpage by a user associated with a particular unique user code;
Receiving user information data incorporating the unique user code;
And thereby associating received user information data with prior visit information data.

15. A method according to claim 14, wherein the unique user code is provided to the user by display of the code on one or more pages of a website.

16. A method according to claim 14, wherein the unique user code is automatically attached to communications sent by the user to the website operator.

17. A method according to claim 14, wherein the unique user code is automatically extracted from a communication sent by the user to the website operator.

18. A method according to claim 14, wherein the user is identified by means of any or all of an IP address, caller ID from a mobile device, VOIP identifier, or a cookie.

19. A method according to claim 14, wherein the unique user code is displayed to the user and/or the unique user code is attached to user communications with the website operator by a cookie.

20. A method according to claim 14, wherein visit information data is recorded by a cookie and communicated to the association module.

21. A method according to claim 14, wherein a communication is received from the user, wherein the communication is in the form of any or all of: a webform, an email, a conversation in person, online, or via a telephone network, post, or a fax.

22. A method according to claim 21, wherein voice recognition software is used to identify and extract the unique user code.

23. A method according to claim 21, wherein optical character recognition software is used to identify and extract the unique user code.

24. A method according to claim 14, wherein the user inputs the unique user code via a local or remote data input interface connected to or provided with the communication module.
